(19) United States
(12) Patent Application Publication
(10) Pub. No.: US 2014/0358686 A1
(43) Pub. Date: Dec. 4, 2014

(54) SELECTING A DISPLAY OF AN ADVERTISEMENT BASED ON AVAILABILITY

(71) Applicant: Google Inc., Mountain View, CA (US)

(72) Inventors: Joel D. Tesler, Cupertino, CA (US); Udi Manber, Los Altos Hills, CA (US)

(21) Appl. No.: 13/907,815

(22) Filed: May 31, 2013

(51) Int. Cl. G06Q 30/02

(52) U.S. Cl. CPC G06Q 30/0269
USPC 705/14.61; 705/14.66

(57) ABSTRACT

Methods, systems, and apparatus, including computer programs encoded on a computer storage medium, for selecting displays of advertisements based on availability of a user. A computing system receives a request to provide an advertisement for display by a first computing device. The computing system identifies that a particular user of a second computing device is presently available to participate in an interactive session. The computing system selects, for display by the first computing device, a first display for the advertisement, from a plurality of displays for the advertisement, based on the computing system having identified that the particular user is presently available. The computing system transmits for receipt by the first computing device, first information so as to cause the first computing device to display the first display for the advertisement.

### BACKGROUND

An individual may use a computing device to access a webpage. For example, a user may type a Uniform Resource Locator (URL) into an address bar of a web browser, or may select a bookmark or another type of link that is displayed by the web browser. In response, the web browser may retrieve code, from a remote server system, for rendering the webpage, and may render a display of the webpage. The code may include instructions for requesting, from a remote advertising system, an advertisement for display on the webpage. The remote advertising system may select an advertisement based on various criteria, for example, based on an amount bid for the advertisement and other advertisements that are candidates for display on the webpage. The remote advertising system may provide the selected advertisement for display by the computing device as part of the webpage.

### SUMMARY

This specification describes technologies relating to selecting a display of an advertisement based on an availability of a user. As additional description to the embodiments described below, the present disclosure describes the following embodiments.

As additional description to the embodiments described below, the present disclosure describes the following embodiments.

Embodiment 1 is a computer-implemented method. The method includes receiving, by a computing system, a request to provide an advertisement for display by a first computing device. The method includes identifying, by the computing system, that a particular user of a second computing device is presently available to participate in an interactive session between the first computing device and the second computing device, the interactive session including a transmission of audio, video, or audio and video between the first computing device and the second computing device. The method includes selecting, by the computing system and for display by the first computing device, a first display for the advertisement, from a plurality of displays for the advertisement, based on the computing system having identified that the particular user is presently available. The method includes transmitting, by the computing system and for receipt by the first computing device, first information so as to cause the first computing device to display the first display for the advertisement.

Embodiment 2 is the computer-implemented method of embodiment 1, wherein identifying that the particular user of the second computing device is presently available includes identifying that a schedule indicates that the particular user is available, the schedule having been specified by the particular user or a colleague of the particular user at an organization at which the particular user is employed, the schedule identifying multiple periods of unavailability and multiple periods of availability for the particular user.

Embodiment 3 is the computer-implemented method of any one of embodiments 1 to 2, wherein identifying that the particular user of the second computing device is presently available includes identifying that the particular user has indicated a present availability through interaction with the second computing device.

Embodiment 4 is the computer-implemented method of any one of embodiments 1 to 3, wherein identifying that the particular user of the second computing device is presently available includes identifying that the particular user is not participating in another interactive session with another computing device.

Embodiment 5 is the computer-implemented method of any one of embodiments 1 to 4, wherein the interactive session between the first computing device and the second computing device is to be provided by a server system that is configured to charge a first user of the first computing device for participation in the interactive session, and provide to the particular user, or a colleague of the particular user at an organization at which the particular user is employed, at least a portion of the amount charged to the first user.

Embodiment 6 is the computer-implemented method of any one of embodiments 1 to 5, wherein the transmission of the audio, video, or audio and video includes a real-time transmission of the audio, video, or audio and video, wherein the audio, video, or audio and video is to be captured by one of the first computing device and the second computing device and to be transmitted to an other of the first computing device and the second computing device.

Embodiment 7 is the computer-implemented method of any one of embodiments 1 to 6, wherein each of the plurality of displays for the advertisement markets a service provided by the particular use through use of the interactive session.

Embodiment 8 is the computer-implemented method of any one of embodiments 1 to 7, wherein, the computing system is configured to transmit second information so as to cause the first computing device to present a second display for the advertisement, from the plurality of displays for the advertisement, based upon the computing system identifying that the particular user is presently unavailable.

Embodiment 9 is the computer-implemented method of embodiment 8, wherein: the first display for the advertisement is a first advertisement that was produced by, or on behalf of, the particular user or a colleague of the particular user at an organization at which the particular user is employed; and the second display for the advertisement is a second advertisement that is different from the first advertisement and that was produced by, or on behalf of, the particular user or the colleague of the particular user.

Embodiment 10 is the computer-implemented method of embodiment 8, wherein: (i) the first display for the advertisement is a display of a particular advertisement with an additional element, and the second display for the advertisement is a display of the particular advertisement without the additional element, or (ii) the first display for the advertisement is the display of the particular advertisement without the additional element, and the second display for the advertisement is the display of the particular advertisement with the additional element.

Embodiment 11 is the computer-implemented method of embodiment 10, wherein the display of the particular advertisement with the additional element is a display of the particular advertisement with the additional element superimposed over the display of the particular advertisement.

Embodiment 12 is the computer-implemented method of any one of embodiments 8 to 11, wherein: the transmitted first information is configured such that selection, by a first user of the first computing device, of the first display for the advertisement results in the first computing device initiating the interactive session; and the transmitted second information is configured such that selection, by the first user, of the second display for the advertisement results in the first computing device not initiating the interactive session and instead navigating to a particular website.

Embodiment 13 is the computer-implemented method of embodiment 12, wherein the particular website: displays a schedule of times that the particular user is scheduled to be available for participation in the interactive session, or enables the first user to arrange an appointment with the particular user for participation in the interactive session.

Embodiment 14 is a computer-implemented method. The method includes receiving, by a computing system, a request to provide an advertisement for display by a first computing device. The method includes identifying, by the computing system, that a particular user of a second computing device is presently unavailable to participate in an interactive session between the first computing device and the second computing device, the interactive session including a transmission of audio, video, or audio and video between the first computing device and the second computing device. The method includes selecting, by the computing system and for display by the first computing device, a first display for the advertisement, from a plurality of displays for the advertisement, based on the computing system having identified that the particular user is presently unavailable. The method includes transmitting, by the computing system and for receipt by the first computing device, first information so as to cause the first computing device to display the first display for the advertisement.

Embodiment 15 is the computer-implemented method of embodiment 14, wherein the interactive session between the first computing device and the second computing device is to be provided by a server system that is configured to charge a first user of the first computing device for participation in the interactive session, and provide to the particular user, or a colleague of the particular user at an organization at which the particular user is employed, at least a portion of the amount charged to the first user.

Embodiment 16 is the computer-implemented method of any one of embodiments 14 to 15, wherein the transmission of the audio, video, or audio and video includes a real-time transmission of the audio, video, or audio and video, wherein the audio, video, or audio and video is to be captured by one of the first computing device and the second computing device and to be transmitted to an other of the first computing device and the second computing device.

Embodiment 17 is the computer-implemented method of any one of embodiment 14 to 16, wherein each of the plurality of displays for the advertisement markets a service provided by the particular use through use of the interactive session.

Embodiment 18 is the computer-implemented method of any one of embodiments 14 to 17, wherein, the computing system is configured to transmit second information so as to cause the first computing device to present a second display for the advertisement, from the plurality of displays for the advertisement, based upon the computing system identifying that the particular user is presently available.

Embodiment 19 is the computer-implemented method of embodiment 18, wherein: the transmitted first information is configured such that selection, by the first user, of the second display for the advertisement results in the first computing device not initiating the interactive session and instead navigating to a particular website; and the transmitted first information is configured such that selection, by a first user of the first computing device, of the first display for the advertisement results in the first computing device initiating the interactive session.

Embodiment 20 is the computer-implemented method of embodiment 19, wherein the particular website: displays a schedule of times that the particular user is scheduled to be available for participation in the interactive session, or enables the first user to arrange an appointment with the particular user for participation in the interactive session.

Embodiment 21 is directed to one or more recordable media having instructions stored thereon that, when executed by one or more processors, cause performance of actions according to the method of any one of embodiments 1 to 20.

Embodiment 22 is directed to a system that includes one or more recordable media having instructions stored thereon that, when executed by one or more processors, cause performance of actions according to the method of any one of embodiments 1 to 20.

Particular embodiments of the subject matter described in this specification can be implemented so as to realize one or more of the following advantages. A display of an advertisement that is shown to a particular user may indicate whether selection of the advertisement results in immediate help from an expert user, or whether the particular user is only able to obtain help from the expert user at some future point in time (e.g., an hour or more later). An advertiser may prefer that displays of its advertisements are only available when a representative of the advertiser is able to engage in interactive sessions, so that the advertisements are likely to deliver a greater return on investment (e.g., due to compensation received through follow-on interactive sessions). Similarly, advertisers may be willing to bid greater amounts for display of advertisements during times when the advertisers are available to engage in the interactive sessions. An indication, presented with an advertisement, whether the expert user is immediately available to participate in the interactive session may result in a higher click-through rate than if the advertisement did not identify availability of the expert.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a block diagram of an example environment in which one or more systems select which of multiple displays for an advertisement to present for display.

FIG. 2 shows an illustration of a webpage providing different displays of an advertisement, based on an availability of an expert user.

FIG. 3 shows three scenarios for advertisements that an expert user can upload to an advertising system for selection based on availability of the expert user.

FIGS. 4A-D show a swim-lane diagram of a process for selecting advertisements for display to a user, and related processes.

Like reference numbers and designations in the various drawings indicate like elements.

### DETAILED DESCRIPTION

### Overview

This specification describes technologies relating to selecting which of multiple displays for an advertisement a computing device is to present. The selection may be based on an availability of an expert user that would provide a service identified by the advertisement if a user viewing the advertisement clicked on the advertisement. As an example, a computing device may display one form of an advertisement when the expert user is identified as being available to provide the service, and another form of the advertisement when the expert user is not identified as being available to provide the service.

The service may be provided through an audio or video conference established between a computing device at which the display of the advertisement was provided, and another computer at which the expert user is available for participating in the audio or video conference. As an illustration, a participant user may be surfing the internet for help with a computer problem and may see a display of an advertisement. The display of the advertisement may indicate that the expert user is presently available to provide technical support. The participant user may select the display of the advertisement, which causes initiation of the audio or video conference between the participant user and the expert user. The participant user may be billed for the audio or video conference and the services provided by the expert user.

The availability of the expert user may be determined based on a schedule that the expert user specified in order to indicate future availability of the expert. In other examples, the availability of the expert user is determined based on interaction by the expert user with a computer at which the expert user is available for participating in the audio or video conference (e.g., a determination that keyboard or mouse movement at the computer has occurred within a defined period of time, or a determination that the expert user selected a user interface element in order to identify the expert user as being presently available). In some examples, the availability of the expert is determined based on whether the expert user is determined to be participating in an interactive session with another user.

### Example Operating Environment

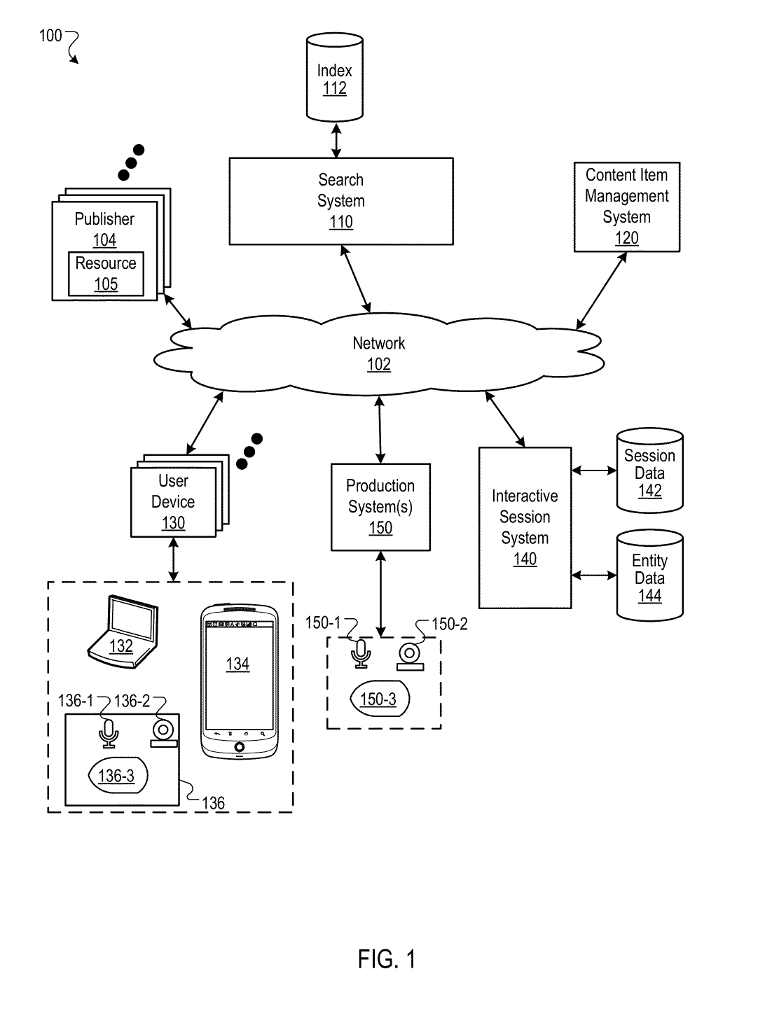

FIG. 1 shows a block diagram of an example environment 100 in which one or more systems select which of multiple displays for an advertisement to present for display. A data communication network 102 enables data communication between multiple electronic devices. Users can access content, provide content, exchange information, and participate in interactive sessions by use of the devices and systems that can communicate with each other over the network 102. The network 102 can include, for example, a local area network (LAN), a cellular phone network, a wide area network (WAN), e.g., the Internet, or a combination of them. The links on the network can be wireline or wireless links or both.

A publisher website 104 includes one or more resources 105 associated with a domain and hosted by one or more servers in one or more locations. Generally, a website is a collection of webpages formatted in hypertext markup language (HTML) that can contain text, images, multimedia content, and programming elements, for example, scripts. Each website 104 is maintained by a content publisher, which is an entity that controls, manages and/or owns the website 104.

A resource is any data that can be provided by a publisher website 104 over the network 102 and that has a resource address, e.g., a uniform resource locator (URL). Resources may be HTML pages, electronic documents, image files, video files, audio files, and feed sources, to name just a few. The resources may include embedded information, e.g., meta information and hyperlinks, and/or embedded instructions, e.g., client-side scripts.

In operation, a search engine or search system 110 crawls the publisher web sites 104 and indexes the resources 105 provided by the publisher web sites 104 in an index 112. The search engine 110 can receive queries from user devices 130. In response to each query, the search engine 110 searches the index 112 to identify resources and information that are relevant to the query. The search engine 110 identifies the resources in the form of search results and returns the search results to the user device 130. A search result is data generated by the search engine 110 that identifies a resource or provides information that satisfies a particular search query. A search result for a resource can include a webpage title, a snippet of text extracted from the webpage, and a resource locator for the resource, e.g., the URL of a webpage.

The search results are ranked based on scores related to the resources identified by the search results, e.g., information retrieval (“IR”) scores, and optionally a separate ranking of each resource relative to other resources, e.g., an authority score. The search results are ordered according to these scores and provided to the user device according to the order.

A user device 130 receives the search results and presents them to a user. If a user selects a search result, the user device 130 requests the corresponding resource. The publisher of the web site 104 hosting the resource receives the request for the resource and provides the resource to the user device 130.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The content item management system 120 provides content items for presentation with the resources 105. A variety of appropriate content items can be provided—one example content item is an advertisement. In the case of advertisements, the content item management system 120 allows advertisers to define selection rules that take into account attributes of the particular user to provide relevant advertisements for the users. Example selection rules include keyword selection, in which advertisers provide bids for keywords that are present in either search queries or resource content or metadata. Advertisements that are associated with keywords having bids that result in an advertisement slot being awarded in response to an auction are selected for displaying in the advertisement slots.

When a user of a user device 130 selects an advertisement, the user device 130 generates a request for a landing page of the advertisement, which is sometimes a webpage of the advertiser. The relevant advertisements can be provided for presentation on the resources 105 of the publishers 104, or on a search results page resource. For example, a resource 105 from a publisher 104 may include instructions that cause a user device to request advertisements from the content item management system 120. The request includes a publisher identifier and, optionally, keyword identifiers related to the content of the resource 105. The content item management system 120, in turn, provides one or more advertisements to the requesting user device. As discussed in further detail below, the content item management system 120 may take into account whether expert users that are affiliated with individual advertisements in a selection of which one or more advertisements to provide to the requesting user device. With respect to a search results page, the user device renders the search results page and sends a request to the content item management system 120, along with one or more keywords related to the query that the user provided to the search engine 110. The content item management system 120, in turn, provides one or more advertisements to the requesting user device.

In the case of advertisements, the content item management system 120 includes a data storage system that stores campaign data and performance data. The campaign data stores advertisements, selection information, and budgeting information for advertisers. The performance data stores data indicating the performance of the advertisements that are served. Such performance data can include, for example, click-through rates for advertisements, the number of impressions for advertisements, and the number of conversions for advertisements. Other performance data can also be stored.

The campaign data and the performance data are used as input to an advertisement auction. In particular, the content item management system, in response to each request for one or more advertisements, conducts an auction to select one or more advertisements that are provided in response to the request. The advertisements are ranked according to a score that, in some implementations, is proportional to a value based on an advertisement bid and one or more parameters specified in the performance data. The ranking may account for whether expert users associated with the advertisements are identified as being available to provide services affiliated with the advertisements. The highest ranked advertisements resulting from the auction are selected and provided to the requesting user device.

A user device 130 is an electronic device, or collection of devices, that is capable of requesting and receiving resources over the network 102. Example user devices 130 include personal computers 132, mobile communication devices 134, and other devices that can send and receive data over the network 102. A user device 130 typically includes a user application, e.g., a web browser, that sends and receives data over the network 102, generally in response to user actions. The web browser can enable a user to display and interact with text, images, videos, music and other information typically located on a webpage at a website on the world wide web or a local area network.

An interactive session system 140 is also accessible by the user devices 130 over the network 102. The interactive session system 140 serves interactive sessions and data related to interactive sessions to users of user devices 130. The term “interactive session” is used in this specification to refer to a presentation that allows at least one user involved in the interactive session to experience an event or receive data related to the event. Events of different types can be presented. In some implementations, events may be “assistance” events, for which interactive sessions provide step-by-step assistance to users to accomplish a particular task, or events may be “experience” events, for which interactive sessions provide users with an experience of participating in an activity. An example interactive session for an assistance event is a session that describes a step-by-step process to build a computer. An example interactive session for an experience event is a session that provides the experience of driving a certain make and model of an automobile. The interactive session system 140 may also provide interactive sessions for other appropriate event types.

Furthermore, the data that the interactive session system 140 provides for an event may also differ based on the event type and based on the intent of the user. For example, interactive sessions for repair events may provide users with a list of tools and parts required to accomplish a task at the beginning of an interactive session. Likewise, a user may have implicitly or explicitly specified an intent for viewing an interactive session. The user may explicitly specify an intent, for example, by interacting with a user interface element that represents their intent. A user may implicitly specify an intent, for example, by submitting a search query that is related to the intent, or by requesting other information that is related to the intent. For example, a user request for information about purchasing tools needed to repair a computer may be considered an implicit indication of the user's intent to repair a computer.

The interactive session system 140 may also determine specific data to provide based on the intent. For example, a user that is viewing a session that describes building a computer, and with the intent to build the computer, may be presented with additional information, e.g., a list of parts, tools and the time required to complete the task. Another user that is watching the same session with the intent to learn about computers may be presented with other information, e.g., articles about memory, heat dissipation, or other computer-related topics, in a side panel of a viewing environment as the interactive session is presented.

The interactive sessions can be created by assistants, such as expert assistants (referred to herein sometimes as “expert users”), or non-expert users. An “assistant” can be a user or entity that has been accepted by the system 170 for a category, e.g., as a result of the user's or entity's having provided credentials or demonstrated a high level of skill. An “expert assistant” may be an assistant with a high level of skill or expertise in a particular area. Examples of expert assistants include a licensed contractor for construction related videos or a company that produces sessions for a particular product the company manufactures and a user that has produced a large number of highly rated sessions. An assistant does not have to have a particular level of skill or have produced a large number of highly rated sessions. For example, an assistant may simply be a friend or acquaintance of another user that knows how to accomplish a task, such as programming a universal remote control. This assistant and the other user can participate in an interactive session where the assistant helps the other user program a universal remote control.

In some implementations, the content item management system 120 can provide content items with the interactive sessions. In the case of advertisements, the content item management system 120 may select advertisements based on the subject matter of a session, the event type, and the user's intent. For example, for a repair event, the content item management system 120 may provide advertisements for providers of tools and parts that are listed in the list of tools and parts required to accomplish the repair task.

Production systems 150 can be used to create sessions. Production systems 150 may range from studios to simple hand-held video recording systems. Generally, a production system 150 is a system that includes one or more of an audio input device 150-1, a video input device 150-2, an optional display device 150-3, and optionally other input and output devices and production processes that are used to create interactive sessions. For example, post production processes may be used to add metadata to an interactive session. Such metadata may include, for example, keywords and topical information that can be used to classify the session to one or more topical categories; a list of tools and parts required for a particular session and descriptions of the tools and parts; and so on. Similarly, user devices 130 may include one or more of an audio input device 136-1, a video input device 136-2, an optional display device 136-3, and optionally other input and output devices and processes that are used to participate in interactive sessions. In some examples, the expert user transmits a video feed and an audio feed for output to the participant user, but the participant user transmits only an audio feed (no video feed) or only typed communication (no audio feed and no video feed) for output to the expert user.

Tactical sensory input devices may also be used in a production system 150. For example, a particular interactive session may provide input data for a “G-suit” that applies pressure to a user's body and that the user interprets as simulated motion. Accordingly, appropriate input systems are used in the production system 150 to generate and store the input data for the interactive session.

Production systems 150 may also be or include devices that are attached to a person. For example, for “point of view” sessions, wearable computer devices that include a camera input device and microphone input device may be worn on a user's person during the time the user is creating the session.

The sessions are stored as sessions data 142 and are associated with authoring entities by entity data 144. A user can use a user device 130 to access the interactive session system 140 to request a session. The interactive session system 140 can provide a user interface to the user devices 130 in which interactive sessions are arranged according to a topical hierarchy. In some implementations, the interactive session system 140 includes a search subsystem that allows users to search for interactive sessions. Alternatively, the search system 110 can search the session data 142 and the entity data 144.

A user experiences a session by use of one or more user devices 130. Other types of input and output devices may also be used, depending on the type of interactive session. For example, an augmented reality visor that provides a view of a real-world environment augmented by computer-generated graphics may be used. A tactical sensory input device and a tactical sensory output device that applies pressure to a user's body and that the user interprets as simulated motion or other type of feedback may also be used.

Some interactive sessions may be provided as part of a consultation process, for example when the user cannot find a stored interactive session that fulfills the user's informational needs. To illustrate, an automobile mechanic may contact a user at another location, e.g., the user's home, to consult with the user regarding an automobile repair. The automobile mechanic may then explain to the user, by means of an interactive session that highlights certain parts of the automobile engine as seen from the point of view of the automobile mechanic, certain repairs that are necessary and request authorization from the user to proceed. The user can ask questions and discuss alternatives with the automobile mechanic during the interactive session to make an informed decision.

Illustrations of Selecting a Display of an Advertisement Based on Availability

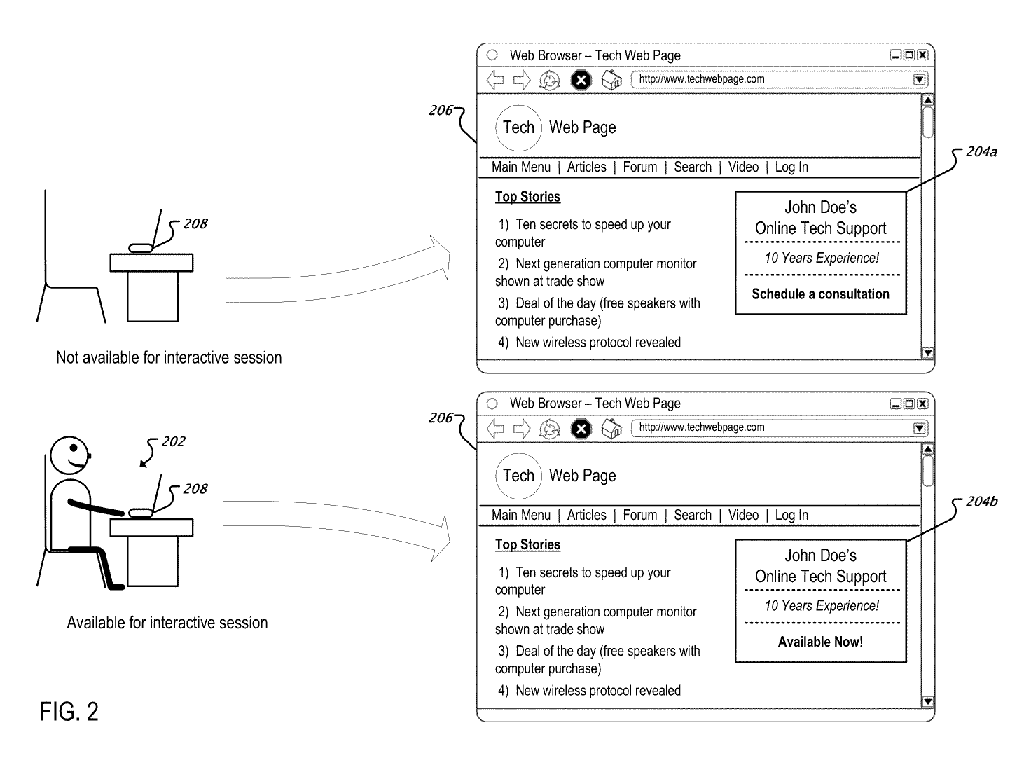

FIG. 2 shows an illustration of a webpage 206 providing different displays of an advertisement, based on an availability of an expert user 202. For example, the webpage 206 may be displayed by one of the user devices 130 in response to a participant user of the one of the user devices 130 navigating to the webpage 206 (e.g., by selecting a bookmark to a URL of the webpage 206). The webpage 206 may include code that requests an advertisement from an advertisement content provider. The advertisement content provider may be different than a website content provider that provided the code for the webpage 206.

The expert user 206 may have uploaded advertisements 204a and 204b to the advertisement content provider, and may have agreed to compensate the advertisement content provider for display of the advertisements 204a and 204b. The expert user 206 may have indicated that the advertisement 204a is to be provided for display by the advertisement content provider (and also that the expert user 206 would be billed) only when the expert user is not determined to be available for an interactive session. The expert user 206 may additionally or alternatively have indicated that the advertisement 204b is to be provided for display by the advertisement content provider (and also that the expert user 206 would be billed) only when the expert user is determined to be available for an interactive session.

This availability of the expert user 202 is shown by the advertisements displayed by webpage 206. For example, advertisement 204b indicates that the expert user is “Available Now!” at a moment during which the expert user 202 is sitting near his computer 208, but the advertisement 204a indicates that a viewing user must “Schedule a consultation” at a moment during which the expert user 202 is away from his computer 208.

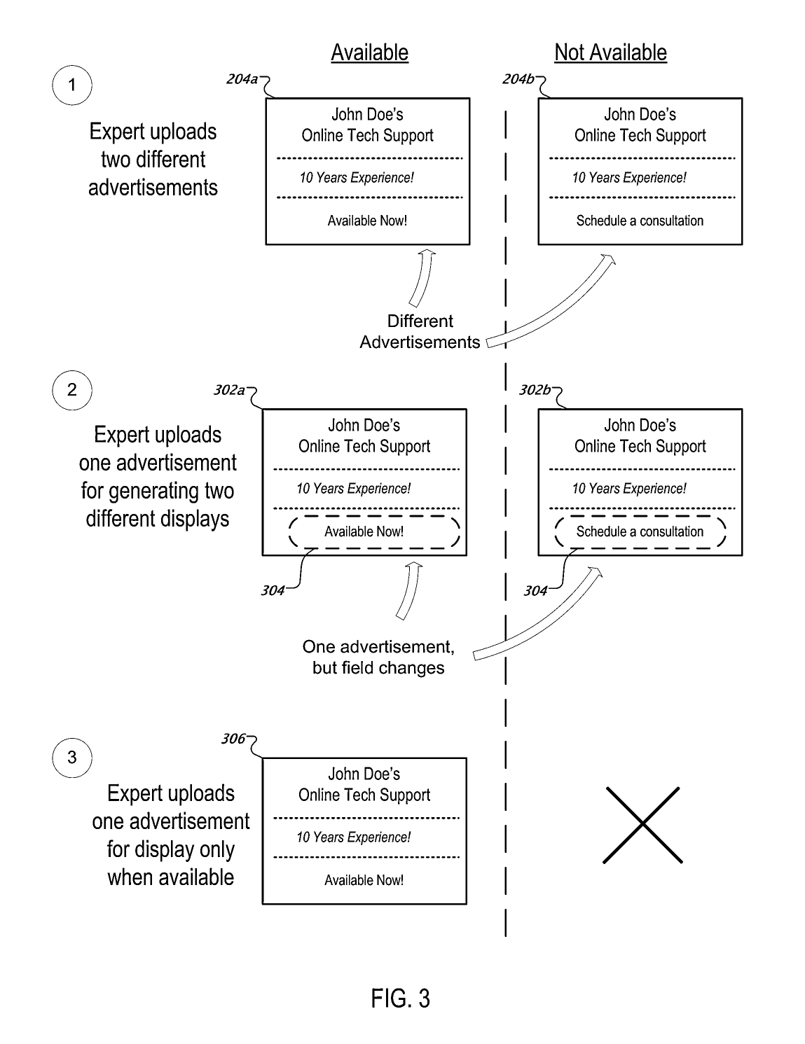

FIG. 3 shows three scenarios for advertisements that an expert user can upload to an advertising system for selection based on availability of the expert user.

In a first scenario, an expert user uploads two different advertisements to the advertising system. For example, the expert user may have created (or requested creation of) two different image files, where one of the image files is to be displayed when the expert user is available for participation in an interactive session, and the other of the image files is to be displayed when the expert user is not available for participation in the interactive session. The expert user may identify which of the advertisements is to be shown when the expert user is available, and which is to be shown when the expert user is not available, by providing input (e.g., selecting radio buttons or pull down menus) to identify which advertisement is to be associated with which availability status. In some examples, each of the advertisements may have been uploaded using a separate advertisement upload interface (e.g., one interface for the “available” advertisement, and one interface for the “unavailable” advertisement). In this example, it can be seen that the advertisement 204a and the advertisement 204b differ only due to the text at the bottom of the advertisement 204a and 204b. The advertisements 204a and 204b, however, may be different image files and thus the advertisements may drastically differ and may not share similar content.

In a second scenario, the expert user uploads a single advertisement and the advertising system either modifies the advertisement, or provides instructions to the device that is to display the advertisement to cause such device to display the advertisement differently based on the availability of the expert user. In this example, the advertisement that the expert user uploads does not include the text “Available Now!” or “Schedule a consultation,” and the advertising system causes the display of the advertisement to include such text, dependent on the availability of the expert user. Such text may also include an indication of one or more times when the expert may be available to participant in an interactive communication, such as the text “Available from 2 PM-5 PM today!”

As an example, the expert user may upload a single advertisement and identify the location of a text or image field 304 on the advertisement. Accordingly, the advertising system may select text or an image for display within the field, dependent on the availability of the expert. The text or image to be displayed within the field may be added to the image by the advertising system (e.g., by modifying the image) before transmission of the image to the computing device at which the advertisement is to be displayed. Alternatively, the advertising system may instruct the computing device at which the advertisement is to be displayed to superimpose the selected text or image over the advertisement. The user may identify a location of the field on the image, or the location of the field may be specified by the advertising system and the expert user may leave the specified region of the field blank or in another manner that accommodates superimposed text or an image. In some examples, the single advertisement may specify a message for one of the available and unavailable modes, and the modification to the advertisement may overwrite the message for display during the other of the available and unavailable modes.

In a third scenario, the expert user uploads a single advertisement 306, and the advertising system displays the single advertisement only when the expert user is available. The advertising system may be configured to display no advertisement that is affiliated with the expert user when the expert user is unavailable.

Additional Description of Process for Selecting Advertisements

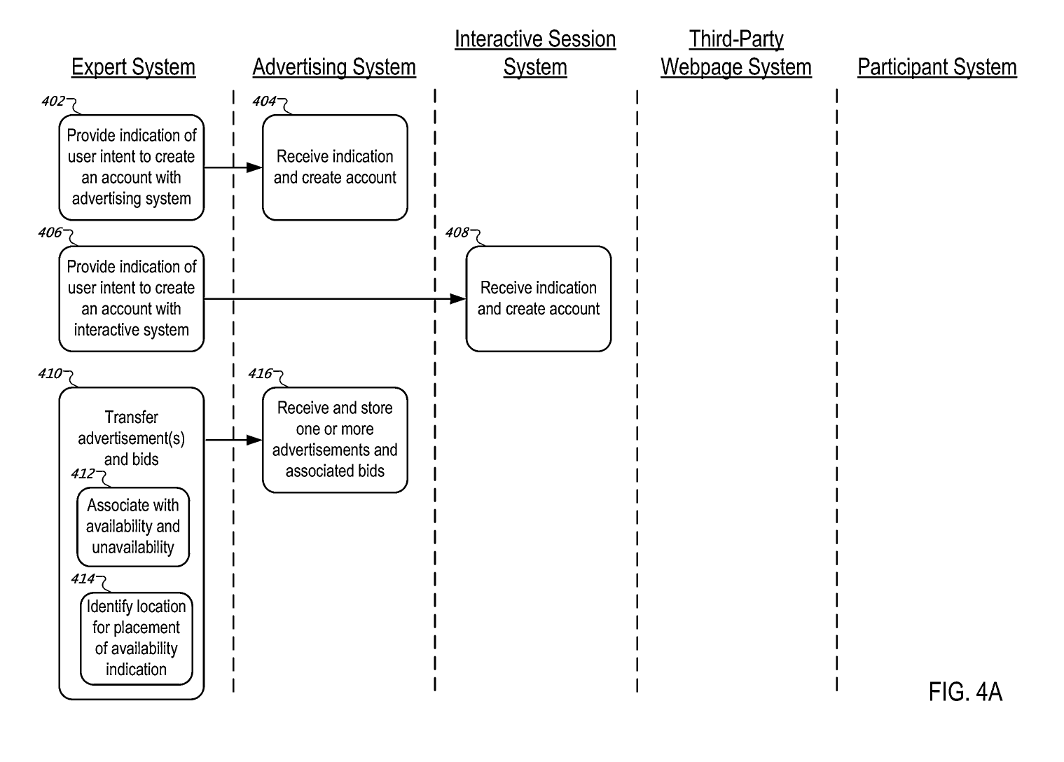

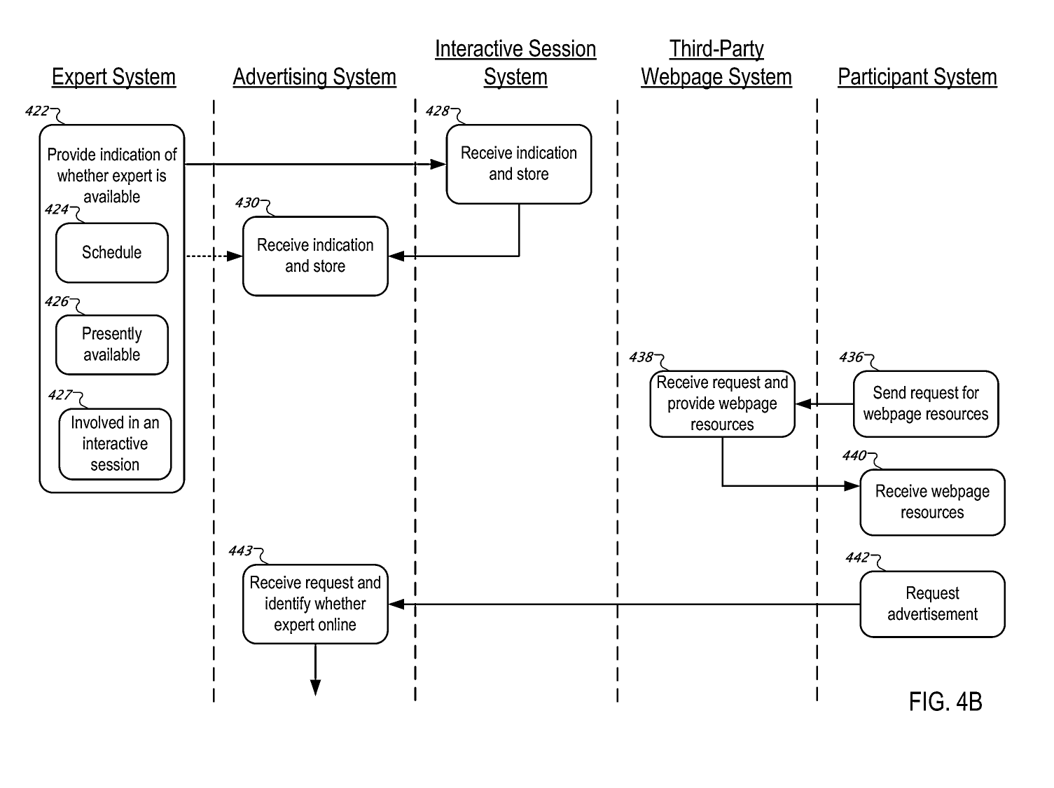

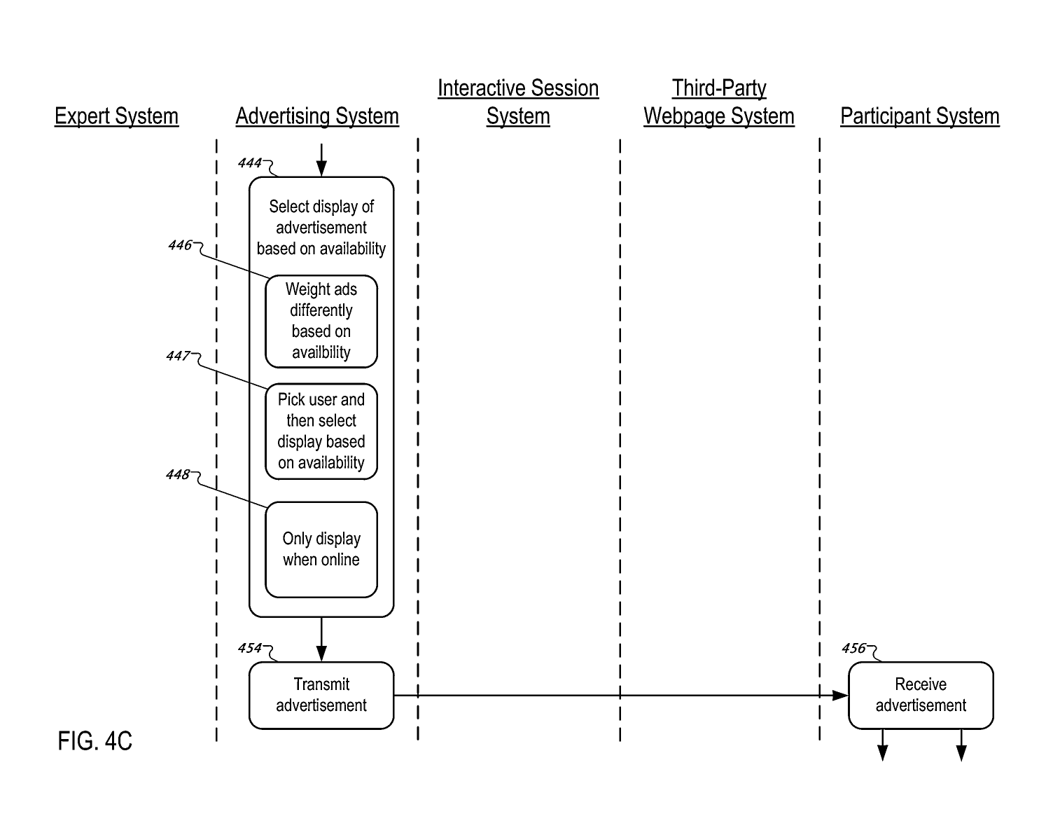

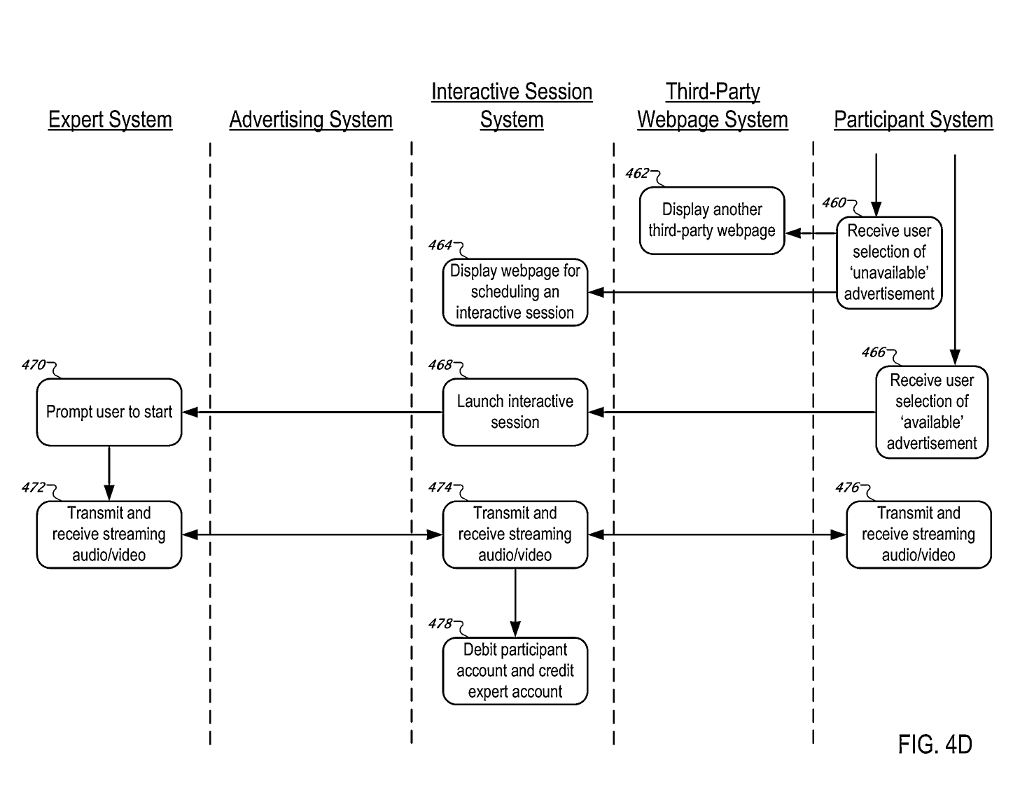

FIGS. 4A-D show a swim-lane diagram of a process for selecting advertisements for display to a user, and related processes. The diagram illustrates operations by at least five systems, an expert system (e.g., the production system 150 in FIG. 1), an advertising system (e.g., the content item management system 120 in FIG. 1), an interactive session system (e.g., the interactive session system 140 in FIG. 1), a third-party webpage system (e.g., a system providing one of the publisher webpages 105 in FIG. 1), and a participant system (e.g., one of the user devices 130 in FIG. 1). Each system may include one or more computing devices cooperating to provide the functionality of the system. Multiple systems may be combined or provided by the same set of computing devices.

At box 402, the expert system provides, for receipt by the advertising system, an indication of user intent to create an account with the advertising system. For example, the expert user may have visited a webpage provided by the advertising system for registering an account, and may have specified various forms of input to register an account. The input may have included a desired user name, a desired password, a mechanism for billing the expert user for provision of advertisements by the advertising system, etc.

At box 404, the advertising system receives the indication of user intent to create the account with the advertising system, and as a result the advertising system creates the user account. For example, the advertising system may form the account so that the expert user can, at a later time, provide a username and password in order to log into the created account and bid on placement of advertisements on third-party webpages.

At box 406, the expert system provides, for receipt by the interactive session system, an indication of user intent to create an account with the interactive session system. For example, the expert user may have visited a webpage provided by the interactive session system for registering account with such system, and may have provided various forms of input to register an account. The input may have included identifying a desired username, a desired password, etc. In some examples, the input included identifying the username for the account with the advertising system so that the interactive session system is able to exchange information with the advertising system with regard to the accounts of the expert user. Alternatively, creating the account for the advertising system may include providing the advertising system with the username for the account for the interactive session system. In some examples, the expert user creates a single account for both the advertising system and the interactive session system.

At box 408, the interactive session system receives the indication of the user intent to create the account with the interactive session system, and as a result creates the user account. For example, the interactive session system may form the account, so that the expert user can at a later time provide a username and password in order to log into the created account and participate in interactive sessions with other users.

Although not shown in FIGS. 4A-D, a participant user of the participant system may similarly create an account with the interactive session system. Both the expert user and the participant user may provide financial information (e.g., credit card account information or bank account information) so as to bill the participant user and compensate the expert user for participating in interactive sessions.

At box 410, the expert system transfers one or more advertisements to the advertising system. For example, the expert user may select one or more advertisements (e.g., one or more image files) for transfer to the advertising system. The advertisements may include one of the sets of one or more advertisements 204a-b, 302a-b, or 306 that are illustrated in the three scenarios shown in FIG. 3.

The expert user may associate each display of an advertisement with a bid amount or a set of bid amounts. The bid or set of bids for the display of an advertisement that is provided when the expert user is available may be different than the bid or set of bids for the display of an advertisement that is provided when the expert user is unavailable. Both bids or sets of bids may be non-zero. As may sometimes be the case, the expert user may be willing to bid a higher amount for display of an advertisement that indicates that the expert user is currently available to participate in an interactive session. The expert user may additionally identify on which webpages the one or more displays of an advertisement are to be shown.

At box 412, the expert system associates a first display of an advertisement that is transferred to the advertising system with availability of the expert user, and a second display of an advertisement that is transferred to the advertising system with unavailability of the expert user. The first display and the second display may be different advertisements that are transferred to the advertising system, or may be displays of the same advertisement that are modified by a system to identify the availability or unavailability of the expert user. As an example, the expert system may send, for receipt by the advertising system, one or more indications of which of the transferred advertisements is to be displayed when the expert user is available or unavailable for participating in an interactive session. Alternatively, the expert system may send, for receipt by the advertising system, text that the expert system is to superimpose over the display of the advertisement for only one of the availability and unavailability statuses of the user.

At box 414, the expert system identifies a location for placement of an availability indication. For example, the expert user may provide input that identifies the placement, size, or placement and size of the field 304 within which the availability indication is to be displayed. An indication of this input may be provided for receipt by the advertising system.

At box 416, the advertising system receives the one or more advertisements and associated bids, and stores the one or more advertisements in association with the user account for the expert user. The advertising system also receives indications of which display of an advertisement is to be associated with an available status of the expert user and which (if any) display of an advertisement is to be associated with an unavailable status of the expert user. The advertising system may also receive an indication of the identified location for placement of the availability indication.

At box 422, the expert system provides, for receipt by the interactive session system or the advertising system, an indication of whether the expert user is available.

At box 424, the indication is a schedule that the expert user generates and that identifies multiple periods of future availability and multiple periods of future unavailability (e.g., where the periods of availability and unavailability may span several days).

At box 426, the indication is an indication that the expert user is presently available. For example, the indication may be provided to the advertising system or interactive session system as a result of the expert user selecting a user interface element to indicate that the expert user is presently available (e.g., an “activate display of ‘available’ advertisement” button). In some examples, the indication may be provided to the advertising system or interactive session system as a result of the expert system identifying that the expert user has recently interacted with the expert system (e.g., that the expert user has not been “away” from his or her computer for an extended period of time due to recent mouse movement). Such an indication that the expert user is presently available may indicate that the advertising system is to display the “available” advertisement until the expert system provides an indication that the expert is unavailable, for example, due to the expert user at a later time selecting a user interface element to indicate that the expert user does not wish to be identified as presently available.

At box 427, the indication is an indication whether the expert user is determined to be participating in an interactive session with another user. For example, the expert system or the interactive session system may determine whether the expert user is presently participating in an interactive session with a participant user. If so, the expert user may be determined to be unavailable. If not, the expert user may be determined to be available. In some examples, the expert user may not provide input that identifies the expert user's availability. For example, the participant user may provide input to terminate an interactive session and, without input from the expert user, the expert system may provide input that indicates that the expert user is available. In some examples, the expert user provides input to start or terminate an interactive session, but the expert user does not provide separate input that identifies whether the expert user is available or unavailable.

At box 428, the interactive session system may receive the indication that the expert user is available for participating in an interactive session and may store such information. The interactive session system may also notify the advertising system that the expert user is available, either immediately or at some later point in time. Alternatively, the expert system may directly notify the advertising system that the expert user is available for participating in the interactive session.

At box 430, the advertising system receives the indication that the expert user is available for participating in the interactive session, either from the interactive session system, or from the expert system.

At box 436, the participant system sends a request for webpage resources. For example, an individual (e.g., the participant user that is discussed throughout the specification) may provide input to his computing device (e.g., a smartphone, tablet, laptop, or desktop computer) that causes his computing device to navigate to a particular webpage. The input may include typing, into a field of a web browser, a URL that identifies a location of resources for the webpage. The input may also include selecting a link that identifies the URL as a target. As a result, the web browser may send the request for the webpage over a network such, as the Internet, for receipt by a third-party webpage system (e.g., a system of one or more servers that responds to requests for the webpage).

At box 438, the third-party webpage system receives the request for the webpage resources and provides the resources for receipt by the participant system. The resources may include one or more of an HTML file, a javascript file, images, etc.

At box 440, the participant system receives the webpage resources. A web browser at the participant system may, without receipt of user input after having received the webpage resources, begin a process for rendering a webpage from the webpage resources.

At box 442, the participant system requests that the advertising system provide a content item, for example, an advertisement. As an example, the resources for rendering the webpage may include code (e.g., javascript code) that when executed causes a request for retrieval of an advertisement for display by the web browser as part of the webpage. Alternatively, the third-party webpage system may request the advertisement from the advertising system, and may include the advertisement with the webpage resources that are sent to the participant system.

At box 443, the advertising system receives the request to provide an advertisement for display by the participant system. As a result, the advertising system may identify whether the expert user is presently available. The advertising system may identify whether the expert user is available based on information that is already stored by the advertising system (e.g., the indication that is stored at box 430). Alternatively, the advertising system may request, from the interactive session system, an indication whether the expert user is available. In some examples, the identification whether the expert user is presently available is performed before receiving the request to provide the advertisement, for example, when the identification whether the expert user is presently available is used, before receiving the request, to weight bids or run an auction to select advertisements.

The availability of the expert user may be an availability regarding whether the expert user is available for participating in an interactive session to be conducted between the expert system and the participant system. The interactive session may include transmission of audio or video between the expert system and the participant system, either as a transmission from the expert system to the participant system, a transmission from the participant system to the expert system, or both. The transmission may be a real-time transmission of the audio or the video, where the audio or the video was captured by one of the expert system and the participant system and transmitted to the other of the expert system and the participant system during the interactive session. The receipt and presentation of the audio or video by the other device may occur within one, two, or three seconds of the audio or video being captured, so as to enable real-time communication between the expert user and the participant user. The interactive session may involve one or more of the expert system and the participant system being able to share a display of the desktop or an application program, so that both the expert user and the participant user view the display of the desktop or the application program on their respective devices.

In various examples, identifying whether the expert user is online includes identifying whether the schedule that the expert user uploaded indicates that the expert user is available or unavailable. In various examples, identifying whether the expert user is online includes identifying whether the expert user has indicated a present availability through interaction with the expert system. Indicating that the user is presently available may be different than the user indicating through specification of a schedule that the user will be available at some future time (but is not presently available). One example of the expert user indicating a present availability includes the expert user having selected a user interface element to log into an account for the interactive session system and place himself on standby for participating in an interactive session that would be initiated by a participant system. Other examples of the expert user indicating a present availability are described elsewhere in this specification.

At box 444, the advertising system selects one of a first display for an advertisement and a second display for an advertisement based on having identified whether the expert user is presently available. The first and the second displays may both be candidates for display by the participant system, and may both advertise services of the expert user. The first and second displays, however, may be different. In some examples, the first and second displays are different advertisements (e.g., advertisement image files). In some examples, the first and second displays include the same advertisement, but the advertising system (or some other system) either modifies the advertisement to personalize the advertisement to a present availability of the expert user, or provides instructions for causing the participant system to modify the advertisement or modify a display of the advertisement to personalize the advertisement to a present availability of the expert user.

Modifying the display of the advertisement may include displaying an additional element with the advertisement. The additional element may be superimposed over the advertisement or may be displayed with the advertisement (e.g., adjacent to the display of the advertisement on the display of the webpage). The first display may be presented upon the advertising system (or some other system, which may be different than or include the advertising system) identifying that the expert user is presently available. The second display may be presented upon the advertising system (or the some other system) identifying that the expert user is presently unavailable.

There are various ways to select a display of an advertisement based on an availability of an expert user, some of which are described below. Generally, though, selecting a display of an advertisement based on an availability of an expert user may involve taking into an account whether the expert user is available or unavailable as part of a determination whether to select a display of an advertisement for presentation in distinction to selecting another display of another advertisement for presentation.

At box 446, the advertising system weights advertisements differently based on an availability of expert users that transferred the respective advertisements. For example, The advertising system may run an auction to determine which of multiple displays for various advertisements to present. Should an expert user be available, the computing system may be configured so that the display for the advertisement that is associated with the “available” status may be more likely to be displayed than if the expert user was unavailable. Conversely, should the expert user be unavailable, the computing system may be configured so that the display for an advertisement that is associated with the “unavailable” status may be more likely to be displayed than if the expert user was available. Weighting the advertisements differently may include applying a different monetary bid for one or more displays of advertisements while the expert user is available than when the expert user is unavailable. The auction that selects an advertisement may involve both bids for the one or more displays of advertisements transferred by a certain expert user, and bids for displays of advertisements by other advertisers (which may include one or more other expert users).

At box 447, the advertising system identifies that an advertisement for a certain expert user is to be displayed, and thereafter selects the form of display for that advertisement based on the identified availability of the expert user. For example, the advertising system may run an action that selects the expert user from a collection of advertisers (which may include other expert users). Upon having identified that the system is to provide an advertisement that the expert user transferred to the advertising system, the advertising system may determine which of multiple displays of an advertisement associated with that expert user to provide, based on the availability of that expert user.

In some examples, the advertising system provides an advertisement for display by the participant system before a determination whether the expert user that is paying for placement of the advertisement is online. The provided advertisement may be associated with the “unavailable” status of the expert user, even though the availability of the expert user has yet to be determined advertising system. The advertising system, or the participant system, may thereafter determine whether the expert system is available, and if the expert user is indeed available, may update the display of the advertisement to the display that is associated with the “available” status. For example, the participant system may present an “unavailable” display of an advertisement, and scripting code included with a webpage may include instructions that, when executed, cause the participant system to communicate with the advertising system or the interactive session system to cause a determination whether the expert user is available, and if so, change to the “available” display.

At box 448, the advertising system is configured to display an advertisement for the expert user only when the expert user is online. For example, the advertising system may determine whether to place an advertisement for the expert user into an auction for filling an advertising slot in a webpage based on whether the expert user is online (e.g., an advertisement would not be included in the auction if the expert user was offline). Alternatively, an auction may be run, and the advertising system may check whether the winning one or more advertisements should be displayed on the webpage based on the availability of the expert user (e.g., even if the advertisement for the expert user won the action, the advertisement may not be displayed if the expert user is not identified as being available).

At box 454, the advertising system transmits information so as to cause the participant system to display the selected one of the first display and the second display. For example, in circumstances in which the advertising system is selecting from multiple advertisement image files that are associated with a certain expert user, the advertising system transmits one of the advertisement image files for receipt by the participant system. In circumstances in which the advertising system is selecting from multiple displays for a single advertisement image file (e.g., whether or not to cause the participant system to superimpose text over the advertisement image file), the advertising system transmits the single advertisement image file, optionally along with instructions for causing the participant system to superimpose the text over the single advertisement image file.

At box 456, the participant system receives the transmitted information and displays the selected one of the first display and the second display. For example the participant system displays the received advertisement, and may perform operations for displaying an element with the advertisement if the participant system received instructions to display the element.

At box 460, the participant system receives an indication that the participant user selected the second display (e.g., the display of the advertisement that is presented when the expert user is unavailable). As a result, the web browser requests resources for a different webpage, and navigates to a display of the different webpage.

At box 462, the different webpage is a third-party webpage. The third-party webpage may be administered by an entity that is different than an entity that administers the interactive session system. Indeed, the different entity may be the expert user. As an illustration, when a user selects an advertisement for services of an expert user when that expert user is not online, the user's web browser may navigate to a display of a webpage that is hosted on behalf of the expert user. The expert user may specify the URL for the webpage at a time when the advertisement is transferred to the advertising system, or otherwise by logging into the expert's account with the advertising system.

At box 464, the different webpage is a webpage for scheduling an interactive session. As an illustration, when a user selects an advertisement for services of an expert user when that expert user is not online, the user's web browser may navigate to a display of a webpage that is hosted by the interactive session system, or that is in communication with the interactive session system. The participant user may be able to view one or more times at which the expert user is identified as being available for an interactive session, and the participant user may reserve one of the times. The indication of the time that the participant user selected, along with information that identifies the participant user, may be transmitted to the expert system for display to the expert user.

At box 466, the participant system receives an indication that the participant user selected the first display (e.g., the display of the advertisement that is presented when the expert user is available). As a result of the selection, the participant system performs operations for initiating the interactive session. The operations to initiate the interactive session may involve the participant session transferring an indication, for receipt by the interactive session system, that the participant user would like to establish an interactive session with the expert user. As a result, the interactive session system may send a communication to the expert system to either cause the expert system to automatically commence the interactive session, or to cause the expert system to prompt the expert user to provide input regarding whether the expert user wishes for the interactive session to commence (box 470).

At box 472, 474, and 476, the expert system and the participant system participate in the interactive session. Communication between the two systems may be administered by the interactive session system such that communications between the expert system and participant system are routed through the interactive session system. Alternatively or in addition, the expert system and the participant system may communicate directly with each other without involving the interactive session system. As discussed throughout this specification, the interactive session can include one of the expert system and the participant system transmitting a real-time video and audio feed for display by the other of the expert system and the participant system. In some implementations, both the expert system and the participant system capture video and audio and communicate with each other using duplex communications.

At box 478, the interactive session system debits an account of the participant user as a result of the participant user having selected the “available” display for the advertisement, and engaging in an interactive session with the expert user. The amount debited may be based on a length of the interactive session, may be specified by the expert user during or at an end of the interactive session, or may be a fixed amount set for initiation of an interactive session, regardless of the length. At least a portion of the amount that the participant user is billed may be provided to the expert user (e.g., 80% to the expert user and 20% to the entity managing the interactive session).

For simplicity in explanation, this specification refers to the expert user as though the expert user were a single user, but it should be understood that operations described as being performed by the expert user may be performed by the expert user and one or more users that may be colleagues that work for a same organization as the expert user. In this manner, the expert user may be considered, for purposes of the description in this patent application, as any individual that works for a particular business entity. For example, one individual in a business may transfer the advertisements and set the bids, while another user may manage the financial accounts that receive payments for interactions, and multiple other users may sit at terminals and perform the services during the interactive sessions. As such, various references to a single expert user can refer to different users that are affiliated with the same organization. In another example, the organization may include a pool of expert users (e.g., technicians at a business) that can participate in interactive sessions, and a display of an advertisement may indicate that an expert user for the organization is available when any one of the expert users in the pool of expert users is available. Only when all of the expert users for the organization are unavailable (e.g., because they are off the clock or are engaged in interactive sessions) may the display of the advertisement indicate, for example, that a user has to schedule a time during which to participate in an interactive session.

Also for simplicity in explanation, this specification refers to an expert user and a participant user, but it should be understood that the operations described with respect to these individuals or entities may be agnostic with regard to the actual individual or entity that is performing the action, and rather identifies that a specific user account may be active over a period of time (e.g., credentials have been provided for logging into the user account). As such, it may not matter for purposes of this specification whether the same human individual is performing multiple operations that are described as being performed, for example, by a “participant user,” but rather it may matter that the same user account is being used. For example, references to a “participant user” may indicate that a same user account was active during performance of certain activities, regardless whether one or more human individuals performed the operations.

This specification refers at times to an “expert user,” but it should be understood that this phrase is used for its ease in description and is not intended to refer only to an individual that has expertise in a particular field. Rather, the use of the phrase should be understood to refer to an individual that can provide a service through an interactive session. Such a service provider does not necessarily require expertise. For example, a user could provide a service of reading for the blind, where a primary skill is an ability to read. Such a user may not be considered to have expertise in the field of reading, even though descriptions in this specification of an expert user would apply to such a service provider.

In some examples, the expert user may be associated with more than the two statuses of available and unavailable. For example, the expert user may also be associated with an “unknown” status, whereby the system may not be able to determine whether the expert user is available or unavailable. The expert user may also be associated with an “idle” status, whereby the expert user was previously indicated as available, but has since not interacted with the computing device for a determined period of time. Accordingly, there may be more than two displays that are candidates for display for a particular expert user. These displays may correspond to the respective more than two statues. In some examples, however, one of the displays for an advertisement corresponds with multiple statuses (e.g., both the “available” status and the “idle” status).

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. However, a computer need not have such devices. Moreover, a computer can be embedded in another device, e.g., a mobile telephone, a smart phone, a mobile audio or video player, a game console, a Global Positioning System (GPS) receiver, and a wearable computer device, to name just a few. Devices suitable for storing computer program instructions and data include all forms of non-volatile memory, media and memory devices, including by way of example semiconductor memory devices, magnetic disks, and the like. The processor and the memory can be supplemented by, or incorporated in, special purpose logic circuitry.

To provide for interaction with a user, embodiments of the subject matter described in this specification can be implemented on a computer having a display device for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input and output.

While this specification contains many specific implementation details, these should not be construed as limitations on the scope of any inventions or of what may be claimed, but rather as descriptions of features specific to particular embodiments of particular inventions.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, by a computing system, a request to provide an advertisement for display by a first computing device;
identifying, by the computing system, that a particular user of a second computing device is presently available to participate in an interactive session between the first computing device and the second computing device, the interactive session including a transmission of audio, video, or audio and video between the first computing device and the second computing device;
selecting, by the computing system and for display by the first computing device, a first display for the advertisement, from a plurality of displays for the advertisement, based on the computing system having identified that the particular user is presently available; and
transmitting, by the computing system and for receipt by the first computing device, first information so as to cause the first computing device to display the first display for the advertisement.

2. The computer-implemented method of claim 1, wherein identifying that the particular user of the second computing device is presently available includes identifying that a schedule indicates that the particular user is available, the schedule having been specified by the particular user or a colleague of the particular user at an organization at which the particular user is employed, the schedule identifying multiple periods of unavailability and multiple periods of availability for the particular user.

3. The computer-implemented method of claim 1, wherein identifying that the particular user of the second computing device is presently available includes identifying that the particular user has indicated a present availability through interaction with the second computing device.

4. The computer-implemented method of claim 1, wherein identifying that the particular user of the second computing device is presently available includes identifying that the particular user is not participating in another interactive session with another computing device.

5. The computer-implemented method of claim 1, wherein the interactive session between the first computing device and the second computing device is to be provided by a server system that is configured to charge a first user of the first computing device for participation in the interactive session, and provide to the particular user, or a colleague of the particular user at an organization at which the particular user is employed, at least a portion of the amount charged to the first user.

6. The computer-implemented method of claim 1, wherein the transmission of the audio, video, or audio and video includes a real-time transmission of the audio, video, or audio and video, wherein the audio, video, or audio and video is to be captured by one of the first computing device and the second computing device and to be transmitted to an other of the first computing device and the second computing device.

7. The computer-implemented method of claim 1, wherein each of the plurality of displays for the advertisement markets a service provided by the particular use through use of the interactive session.

8. The computer-implemented method of claim 1, wherein, the computing system is configured to transmit second information so as to cause the first computing device to present a second display for the advertisement, from the plurality of displays for the advertisement, based upon the computing system identifying that the particular user is presently unavailable.

9. The computer-implemented method of claim 8, wherein:
the first display for the advertisement is a first advertisement that was produced by, or on behalf of, the particular user or a colleague of the particular user at an organization at which the particular user is employed; and
the second display for the advertisement is a second advertisement that is different from the first advertisement and that was produced by, or on behalf of, the particular user or the colleague of the particular user.

10. The computer-implemented method of claim 8, wherein:
(i) the first display for the advertisement is a display of a particular advertisement with an additional element, and the second display for the advertisement is a display of the particular advertisement without the additional element, or
(ii) the first display for the advertisement is the display of the particular advertisement without the additional element, and the second display for the advertisement is the display of the particular advertisement with the additional element.

11. The computer-implemented method of claim 10, wherein the display of the particular advertisement with the additional element is a display of the particular advertisement with the additional element superimposed over the display of the particular advertisement.

12. The computer-implemented method of claim 8, wherein:
the transmitted first information is configured such that selection, by a first user of the first computing device, of the first display for the advertisement results in the first computing device initiating the interactive session; and
the transmitted second information is configured such that selection, by the first user, of the second display for the advertisement results in the first computing device not initiating the interactive session and instead navigating to a particular website.

13. The computer-implemented method of claim 12, wherein the particular website:
displays a schedule of times that the particular user is scheduled to be available for participation in the interactive session, or
enables the first user to arrange an appointment with the particular user for participation in the interactive session.

14. A computer-implemented method, comprising:
receiving, by a computing system, a request to provide an advertisement for display by a first computing device;
identifying, by the computing system, that a particular user of a second computing device is presently unavailable to participate in an interactive session between the first computing device and the second computing device, the interactive session including a transmission of audio, video, or audio and video between the first computing device and the second computing device;
selecting, by the computing system and for display by the first computing device, a first display for the advertisement, from a plurality of displays for the advertisement, based on the computing system having identified that the particular user is presently unavailable; and
transmitting, by the computing system and for receipt by the first computing device, first information so as to cause the first computing device to display the first display for the advertisement.

15. The computer-implemented method of claim 14, wherein the interactive session between the first computing device and the second computing device is to be provided by a server system that is configured to charge a first user of the first computing device for participation in the interactive session, and provide to the particular user, or a colleague of the particular user at an organization at which the particular user is employed, at least a portion of the amount charged to the first user.

16. The computer-implemented method of claim 14, wherein the transmission of the audio, video, or audio and video includes a real-time transmission of the audio, video, or audio and video, wherein the audio, video, or audio and video is to be captured by one of the first computing device and the second computing device and to be transmitted to an other of the first computing device and the second computing device.

17. The computer-implemented method of claim 14, wherein each of the plurality of displays for the advertisement markets a service provided by the particular use through use of the interactive session.

18. The computer-implemented method of claim 14, wherein, the computing system is configured to transmit second information so as to cause the first computing device to present a second display for the advertisement, from the plurality of displays for the advertisement, based upon the computing system identifying that the particular user is presently available.

19. The computer-implemented method of claim 18, wherein:
the transmitted first information is configured such that selection, by the first user, of the second display for the advertisement results in the first computing device not initiating the interactive session and instead navigating to a particular website; and
the transmitted first information is configured such that selection, by a first user of the first computing device, of the first display for the advertisement results in the first computing device initiating the interactive session.

20. The computer-implemented method of claim 19, wherein the particular website:
displays a schedule of times that the particular user is scheduled to be available for participation in the interactive session, or
enables the first user to arrange an appointment with the particular user for participation in the interactive session.
